(19) United States
(12) Patent Application Publication
(10) Pub. No.: US 2003/0102036 A1
(43) Pub. Date: Jun. 5, 2003

(54) Variable control ball valve

(76) Inventor: Hector Cuellar Sosa, Mexico City (MX)

Correspondence Address: Oltman, Flynn & Kubler, Suite 415, 915 Middle River Drive, Ft. Lauderdale, FL, 33304-3585, US

(21) Appl. No.: 09/780,330

(22) Filed: Feb. 12, 2001

(51) Int. Cl. F16K 11/14

(52) U.S. Cl. 137/595; 137/315.2

(57) ABSTRACT

A variable control ball valve includes a valve body containing a valve body flow channel; a valve ball rotatably mounted within the valve body flow channel, the valve ball having a full volume diametric ball channel with a laterally extending ball channel extension having progressively diminishing cross-sectional area; and a mechanism for rotating the valve ball about a ball rotational axis relative to the valve body flow channel; so that when the valve ball is rotated beyond the point at which the ball channel is aligned with the valve body flow channel, the valve body flow channel aligns with progressively narrower segments of the ball channel extension and the flow rate through the valve body flow channel is progressively diminished.

### BACKGROUND OF THE INVENTION

1. Field of the Invention

The present invention relates generally to the field of valves for permitting and preventing fluid flow, and also for establishing various flow rates. More specifically the present invention relates to a variable control ball valve providing precise flow rate adjustment and intended primarily though not exclusively for high end applications in the chemical and petro-chemical industries. The variable control ball valve is of includes a generally conventional valve body containing a valve body flow channel but containing an inventive valve ball having a full volume diametric ball channel with a laterally extending tapered ball channel extension. As a result, when the valve ball is rotated beyond the point at which the ball channel is axially aligned with the valve body flow channel, the valve body flow channel aligns with progressively narrower segments of the ball channel extension so that the flow rate through the valve is progressively diminished. Rotation of the valve ball is stopped at any point to select a flow rate. While ordinary ball valves permit a progressive alteration of the flow rate by rotating the diametric ball channel progressively out of alignment with the valve body flow channel, the present ball valve permits a far more precise, fine tuned selecting of the flow rate.

A second embodiment of the ball valve is contemplated which is a double valve including two parallel flow channels each containing one of the above-described valve balls, each valve ball having a valve stem structure. The valve balls are inventively rotatably interconnected and mounted in tandem to rotate simultaneously, in full synchronization with and in the same direction as the other valve ball.

A preferred, although optional, feature of the valve is an excess pressure indicator including a venturi passageway extending axially within the valve stem structure which is in fluid communication with the ball channel.

2. Description of the Prior Art

There have long been ball valves for regulating the flow of fluids through fluid lines. Prior ball valves permit a progressive alteration of the flow rate by rotating the diametric ball channel progressively out of alignment with the valve body flow channel. A problem with these prior ball valves has been that precise regulation of flow rate is difficult and uncertain, because the flow rate changes rapidly with small rotational movements of the ball. Another problem has been that there is no provision for precise simultaneous flow regulation of ball valves in adjacent fluid lines. Still another problem has been that excessive fluid pressure in the lines has not been readily identifiable.

It is thus an object of the present invention to provide a ball valve which permits a far more precise, fine tuned selecting of the flow rate.

It is another object of the present invention to provide such a ball valve having a ball diametric flow port and lateral extension.

It is still another object of the present invention to provide such a ball valve including means for reading excessive fluid flow rates.

It is finally an object of the present invention to provide such a ball valve which permits precise simultaneous flow regulation of fluid in adjacent fluid lines.

### SUMMARY OF THE INVENTION

The present invention accomplishes the above-stated objectives, as well as others, as may be determined by a fair reading and interpretation of the entire specification.

A variable control ball valve is provided, including a valve body containing a valve body flow channel; a valve ball rotatably mounted within the valve body flow channel, the valve ball having a full volume diametric ball channel with a laterally extending ball channel extension having progressively diminishing cross-sectional area; and a mechanism for rotating the valve ball about a ball rotational axis relative to the valve body flow channel; so that when the valve ball is rotated beyond the point at which the ball channel is aligned with the valve body flow channel, the valve body flow channel aligns with progressively narrower segments of the ball channel extension and the flow rate through the valve body flow channel is progressively diminished.

The ball channel extension preferably has a laterally tapered cross-section. The valve ball preferably is a hollow sphere, including two diametrically opposed full flow ports; where the lateral port extension is contiguous with and extends from one the flow port to and opens into the other flow port and progressively narrows until it reaches and opens into the other flow port. The valve ball alternatively is a hollow sphere having two diametrically opposed circular flow ports and a series of discrete lateral flow ports which are of progressively smaller cross-section; so that at least one of the lateral flow ports aligns with the valve body flow channel at specific selected valve ball orientations. The lateral flow ports optionally are configured as lateral flow slots which are elongate in the direction of the ball rotational axis.

The valve body preferably includes a composite housing including a central ball housing having two opposing faces and a central housing passageway and a valve stem port perpendicular to and opening into the central housing passageway; two opposing ball seating plates fastened onto the opposing faces of the central ball housing, each ball seating plate having plate bolt ports, a plate central port opening into an outwardly protruding and internally threaded tubular fitting defining a segment of the valve body flow channel, where the valve ball is rotatably fitted into the central housing passageway; two annular valve seats, each valve seat having an inwardly tapered ball face resting against the valve ball, the valve seats being located on opposing sides of the valve ball, the seating plates being fitted against the opposing faces of the central ball housing so that the threaded fittings both align with the central housing passageway, ball seating plates are in sealing contact with the opposing faces of the central ball housing, and the internally threaded fittings and the central housing passageway together define the valve body flow channel, and a valve stem structure fitted through the valve stem port and including a valve ball engaging structure.

The variable control ball valve preferably additionally includes a valve mounting structure for securing the ball valve to a system mounting structure. The variable control ball valve preferably still additionally includes a valve stem port in the valve body substantially perpendicular to and opening into the central housing passageway.

The valve mounting structure optionally includes a mounting tube having internal threads for screwing onto an externally threaded system mounting structure, and protruding from the central ball housing the central housing passageway and having a mounting tube proximal end connected to the central ball housing and a mounting tube distal end. The mounting tube distal end preferably is outwardly flared to a wider diameter than the mounting tube proximal end. The variable control ball valve preferably additionally includes a mounting tube port in the central ball housing which interconnects the central housing passageway with the mounting tube to pass fluid through the mounting tube into a separate line.

The variable control ball valve optionally includes two parallel flow channels, each flow channel containing one of the valve balls, each valve ball being connected to a valve stem structure, where the valve balls are rotatably interconnected by gear structures for simultaneous rotation. The gear structures include valve stem gears mounted on each valve stem structure and by a transition gear affixed to a transition stem and rotatably mounted between and meshing with the valve stem gears and causing one valve ball to rotate simultaneously, in full synchronization with and in the same direction as the other valve ball. The gear structures include ball gears drivably interconnected with each other.

The variable control ball valve preferably additionally includes an excess pressure indicator including a venturi passageway extending axially within the valve stem structure and being in fluid communication with the ball channel, the end of the venturi passageway remote from the valve ball including a viewing window, so that when the pressure of fluid flowing through the ball valve exceeds a certain value, a sufficient quantity of fluid passing through the ball valve is drawn into the venturi passageway to pass beside and appear in the viewing window and thereby to alert a system operator of excessive fluid pressure.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of the first embodiment of the inventive ball valve.

FIG. 2 is a partially broken away perspective view of the ball valve of FIG. 1, revealing the valve ball having the primary ball channel and lateral channel extension.

FIG. 3 is a perspective view of the valve ball having the hollow interior and primary ball channel and tapering lateral channel extension.

FIG. 4 is a perspective view of the valve ball having the hollow interior and having primary full flow ports and a series of discrete lateral flow ports.

FIG. 5 is a side view of the valve ball having the tapering outer grooves. In this instance the valve stem structure passes into the valve ball.

FIG. 6 is a perspective view of the valve ball of FIG. 5 mounted on a valve stem structure.

FIG. 7 is a perspective view of the valve ball of FIGS. 5 and 6 mounted within the valve, with one of the ball seating plates and the corresponding valve seat removed.

FIG. 8 is an exploded view of the preferred embodiment of the ball valve.

FIG. 9 is perspective view of the ball valve of FIG. 7 shown from a different angle, with one of the ball seating plates and the corresponding valve seat removed.

FIG. 10 is a side view of the valve of FIGS. 7 and 9.

FIG. 11 is an upper perspective view of the tandem ball valve having valve stem gears drivably interconnected by a transition gear, with the ball seating plates and valve seats removed.

FIG. 12 is a lower perspective view of the tandem ball valve having valve stem gears drivably interconnected by a transition gear, once again having the ball seating plates and valve seats removed.

FIG. 13 is a perspective view of the tandem valve balls having directly attached ball gears drivably interconnected by a transition gear.

FIG. 14 is a perspective view of the embodiment of the ball valve having the excess pressure indicator, showing the valve stem structure in partial cross-section to reveal the venturi passageway and remote end with the window, with the ball seating plates and valve seats removed.

FIG. 15 is a side view of the ball valve of FIG. 14, once again with the ball seating plates and valve seats removed.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

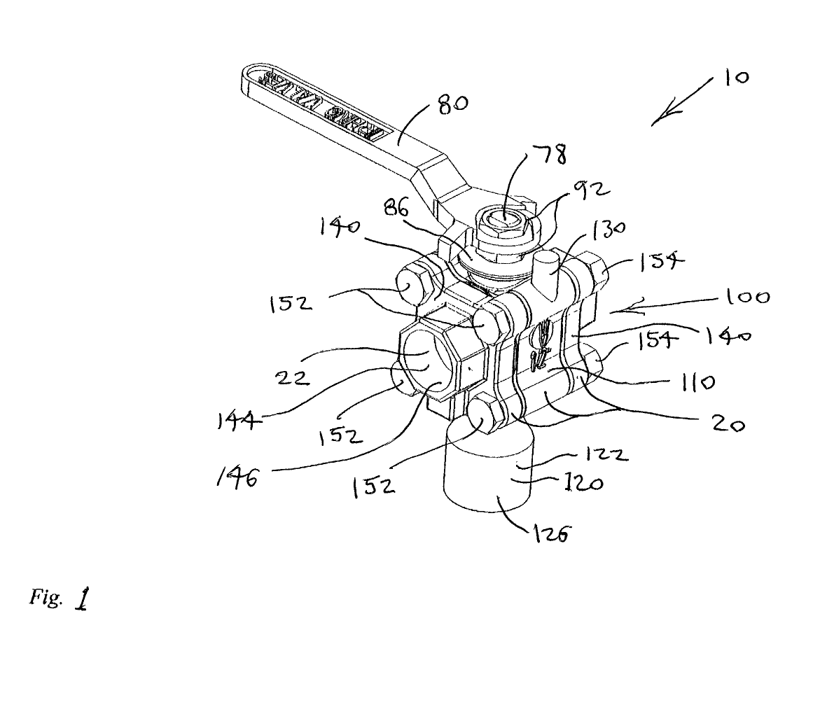

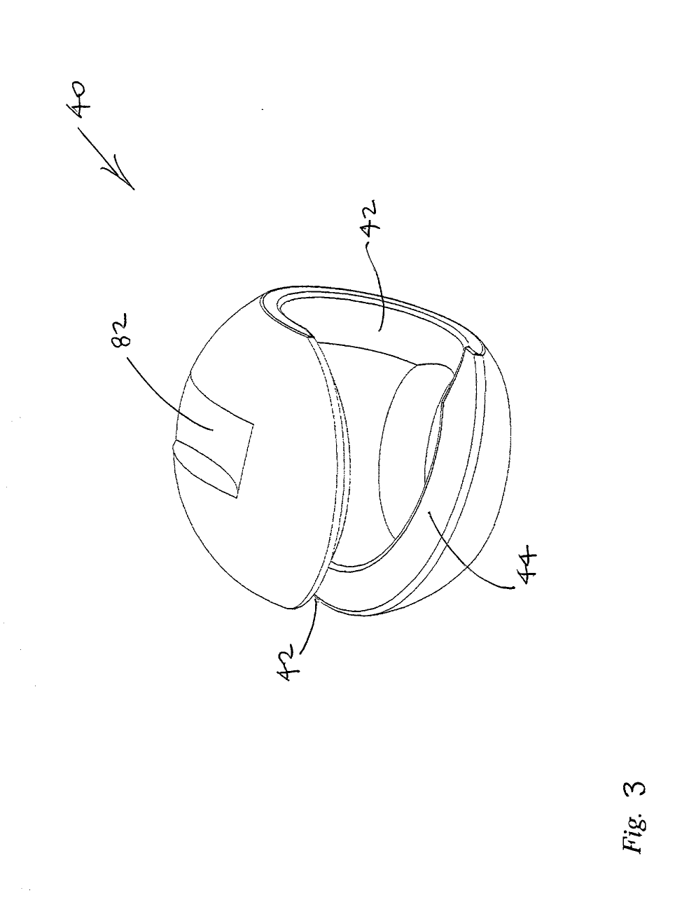

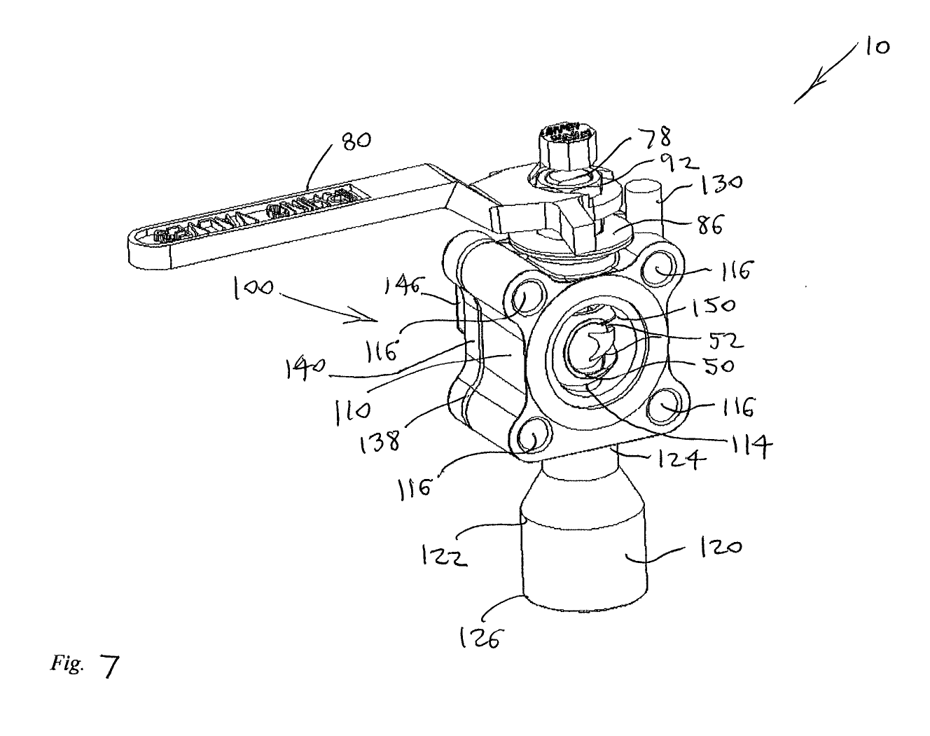

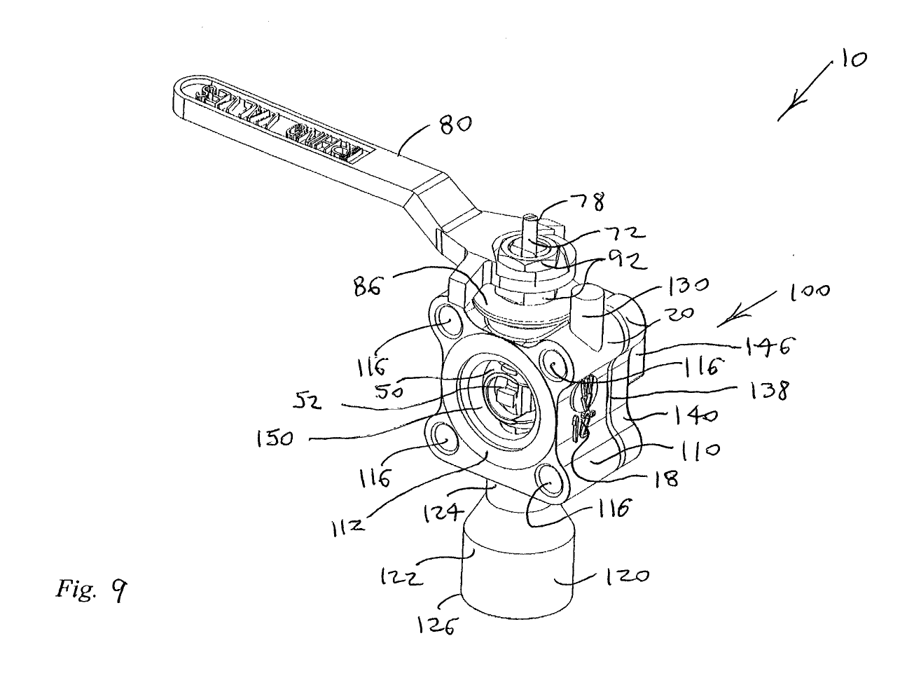

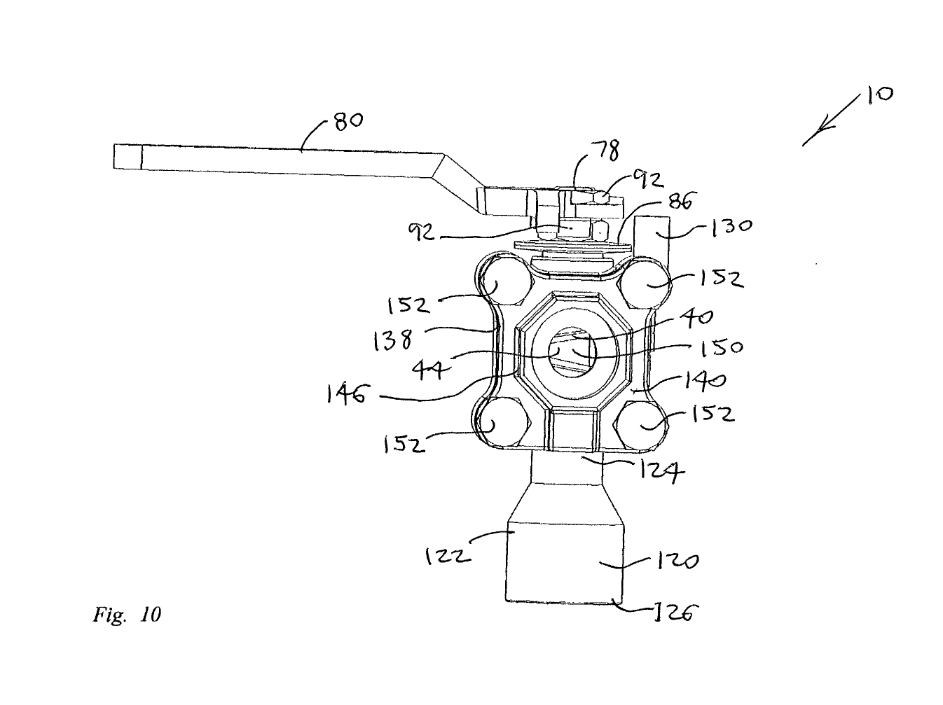

Referring to FIGS. 1-15, a variable control ball valve 10 is disclosed including a valve body 20 containing a valve body flow channel 22 and containing a valve ball 40 having a full volume diametric ball channel 42 with a laterally extending ball channel extension 44 of laterally diminishing flow cross-section. See FIGS. 1-3. As a result, when the valve ball 40 is rotated to the point at which the ball channel 42 is axially aligned with the valve body flow channel 22, fluid flow through ball valve 10 is at its maximum, and when the valve ball 40 is rotated beyond the point at which the ball channel 42 is axially aligned with the valve body flow channel 22, the valve body flow channel 22 aligns with progressively narrower segments of the ball channel extension 44 so that the flow rate through the valve 10 is progressively diminished. Rotation of the valve ball 10, of course, may be stopped at any point to select a desired flow rate. The valve ball 40 of FIG. 3 is a hollow sphere having two diametrically opposed full flow circular flow ports 42 and having a lateral port extension 44 contiguous with and extending from one flow port 42 and progressively narrowing until it reaches and opens into the other flow port 42. Reference numeral 18 designates a company label or trademark emblem on ball valve 10.

Ball valve 10 of the first embodiment is preferably a quarter turn valve. This means that ball valve 10 changes from fully open to fully closed with a quarter turn of the valve ball 40.

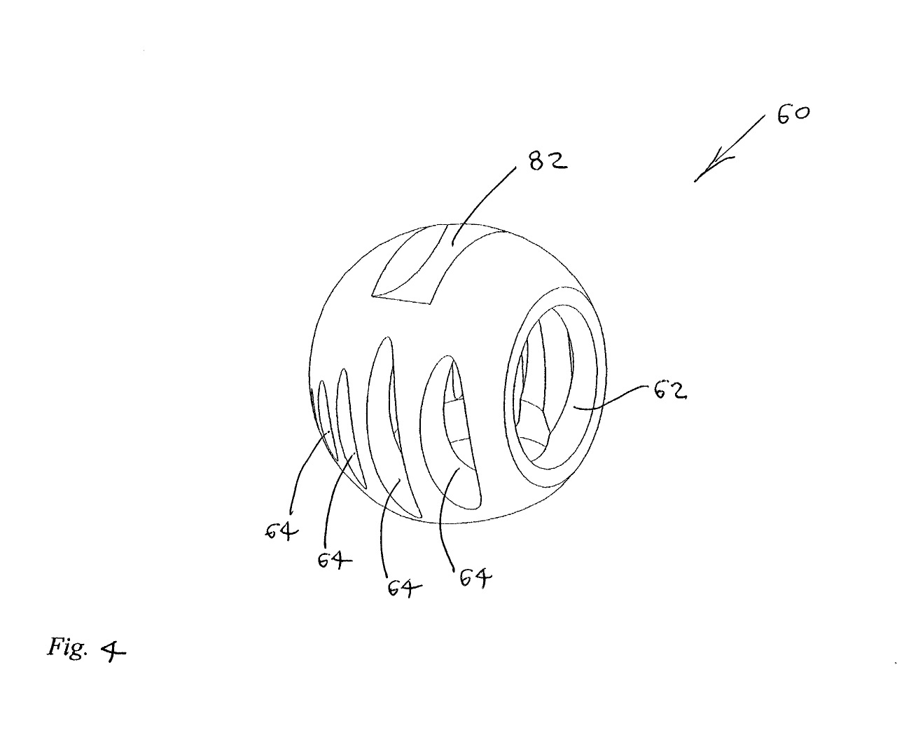

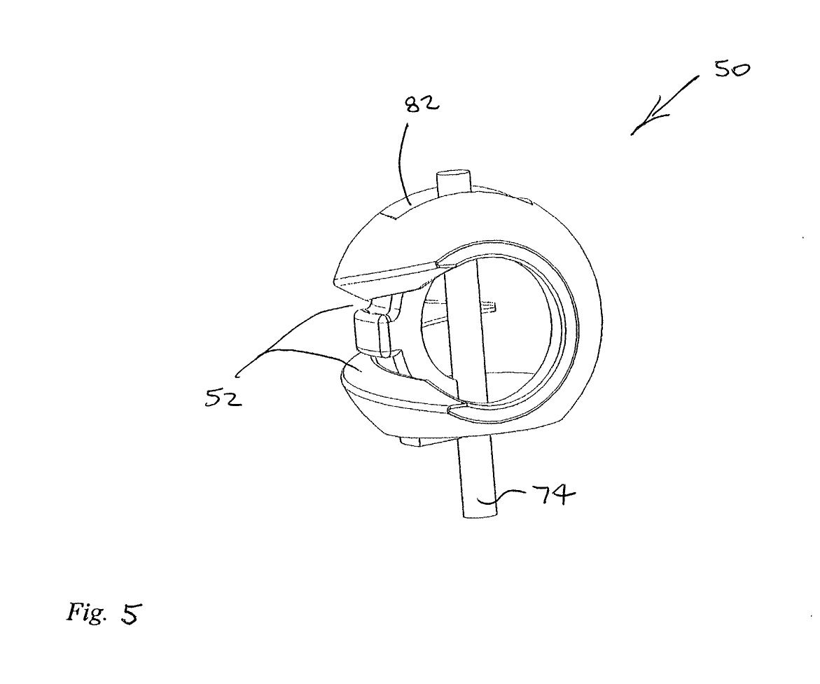

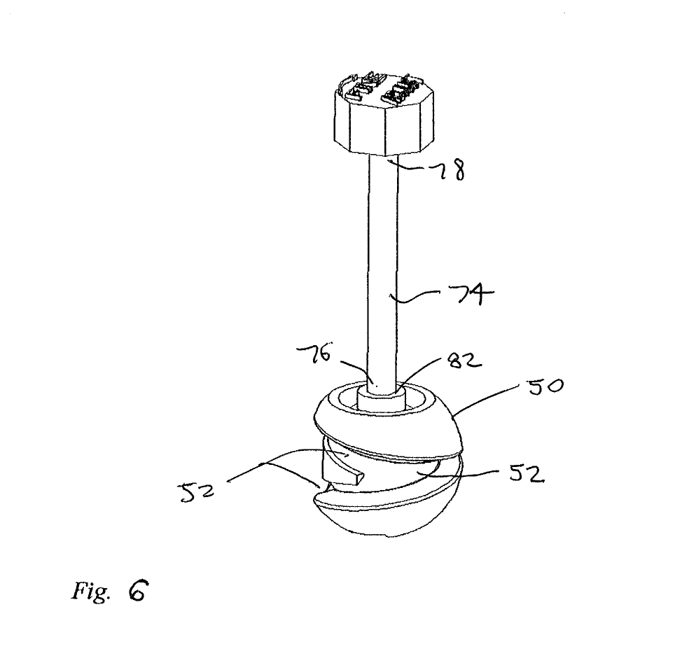

Other valve ball embodiments are contemplated for achieving flow rate precision in substantially the same way, as illustrated in FIGS. 4 and 5. The valve ball 60 of FIG. 4 is a hollow sphere having two diametrically opposed circular primary flow ports 62 and a series of progressively smaller, discrete lateral flow ports 64 in the form of lateral flow slots which are elongate in the direction of the ball rotational axis. The series of lateral flow ports 64 is an alternative to the continuous lateral port extension 54. One or more of the lateral flow ports 64 aligns with the valve body flow channel 22 at specific selected valve ball 60 orientations. The valve ball 50 of FIGS. 5 and 6 shows another variation in which the valve has tapering and converging grooves 52 are in its outer surface to pass fluid. Valve stem structure 70 passes through valve ball 50.

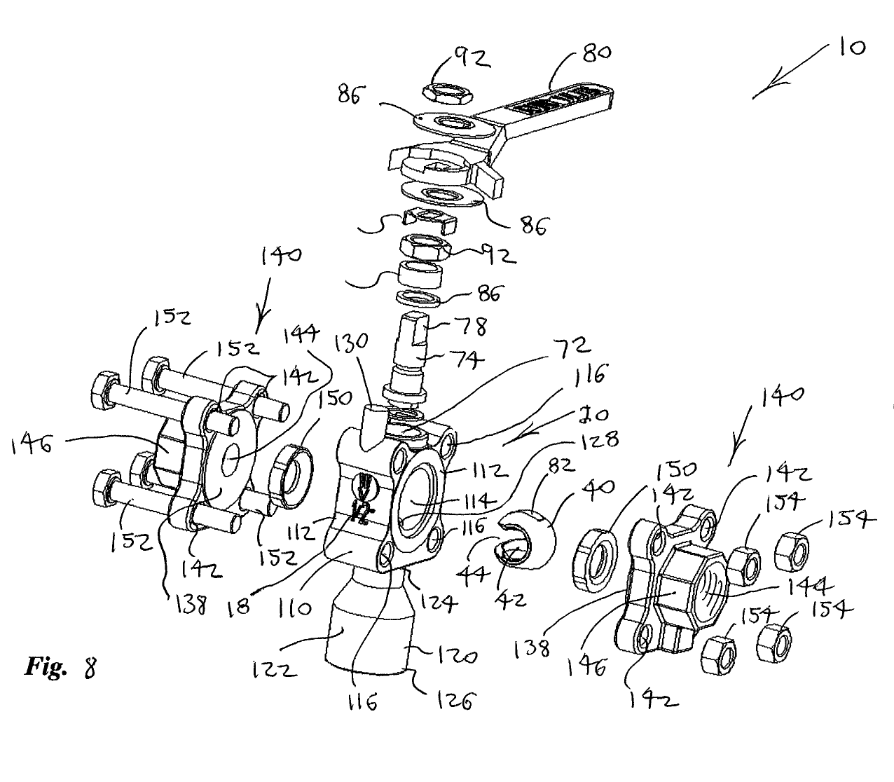

The general elements of the ball valve 10, apart from a valve stem structure 70, are illustrated in the exploded view of FIGS. 8-10. These elements include the composite housing 100 which is made up of a central ball housing 110 having two opposing central ball housing faces 112, a central housing passageway 114, for central ball housing bolt ports 116 substantially equally spaced along its circumference a valve stem port 72 perpendicular to and opening into the central housing passageway 114, and optionally including a valve mounting structure 120 and a venturi port 130 as described below, and further made up of two opposing ball seating plates 140 fastened onto opposing housing faces 112 of the central ball housing 110. Each ball seating plate 140 has four plate bolt ports 142 substantially equally spaced along its circumference, and a plate central port 144 with an outwardly protruding, internally threaded fitting 146 defining a segment of the valve body flow channel 22. The valve ball 40, 50 or 60 is fitted into the central housing passageway 114 in the central ball housing 110. Two annular TEFLON™ valve seats 150 are provided, each seat 150 having an inwardly tapered ball contact face which is placed against the valve ball 40, 50 or 60 such that the valve seats 150 are on diametrically opposed sides of the valve ball 40. The valve seats 150 each have a planar plate face which fits against the inward face of one of the ball seating plates 140 to encircle the plate central port 144. A gasket 138 is preferably placed onto the inward face of each of the ball seating plates 140 and the seating plates 140 are fitted against opposing faces of the central ball housing 110 so that corresponding plate bolt ports 142 of the two ball seating plates 140 are axially aligned with corresponding central ball housing bolt ports 116 and the threaded fittings 146 both axially align with the central housing passageway 114. Plate bolts 152 are fitted through the plate bolt ports 142 and central ball housing bolt ports 116, and nuts 154 are screwed onto the protruding bolt 152 threaded ends until the two ball seating plates 140 are drawn into sealingly contact with the opposing faces of the central ball housing 110. The two internally threaded fittings 146 and the central housing passageway 114 extending between them together define the valve body flow channel 22.

The valve stem structure 70 preferably includes a stem shank 74 having a circular cross-section along its length except at its longitudinal ends, where the shank 74 tapers inwardly to define first and second shank end segments 76 and 78 having rectangular cross-sections. See FIG. 8. The first shank end segment 76 fits into a rectangular shank recess 82 in the valve ball 40, 50 or 60 outer surface to engage the ball for rotation, and the second shank end segment 78 fits into a rectangular lever port 84 in an end of a valve lever 80 so that the valve lever 80 rotatably engages the stem shank 74. The second shank end segment 78 is preferably also externally threaded and of sufficient length that it fits through and protrudes outwardly from the lever port 84. A series of stem shank washers are provided around the shank to minimize friction during shank 74 rotation, the washers 86 preferably including a lock washer, and one or two shank nuts 92 are screwed onto the second shank end segment 78 to secure the valve lever 80 onto the shank 74.

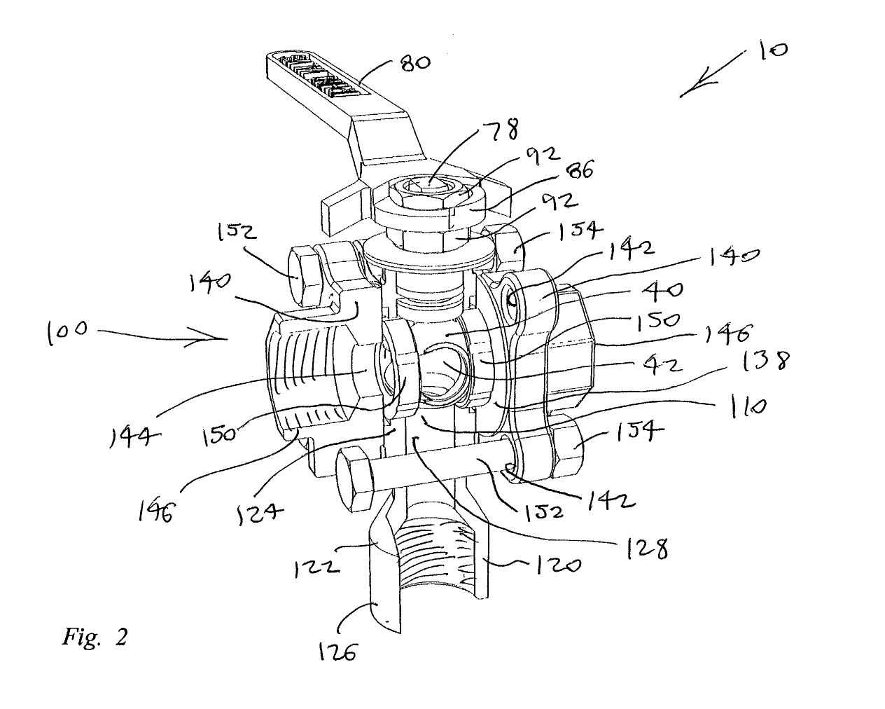

The valve mounting structure 120 is preferably a mounting tube 122 having internal threads so that it can function as a pipe fitting, and protrudes from the central ball housing 110 perpendicular to the axis of the central housing passageway 114 and having a mounting tube proximal end 124 connected to the central ball housing 110 and a mounting tube distal end 126. See FIGS. 1 and 2. The mounting tube 122 is preferably outwardly flared to define an internally threaded mounting tube distal end 122b having a wider diameter than the mounting tube proximal end 122a. The mounting tube distal end 122b is preferably screwed onto an externally threaded valve mount shaft (not shown) on a larger system structure. A mounting tube port 128 is optionally provided in the central ball housing 110 which interconnects the central housing passageway 114 with the interior of the mounting tube 122 so that the mounting tube 122 can receive fluid from a separate line for specific applications.

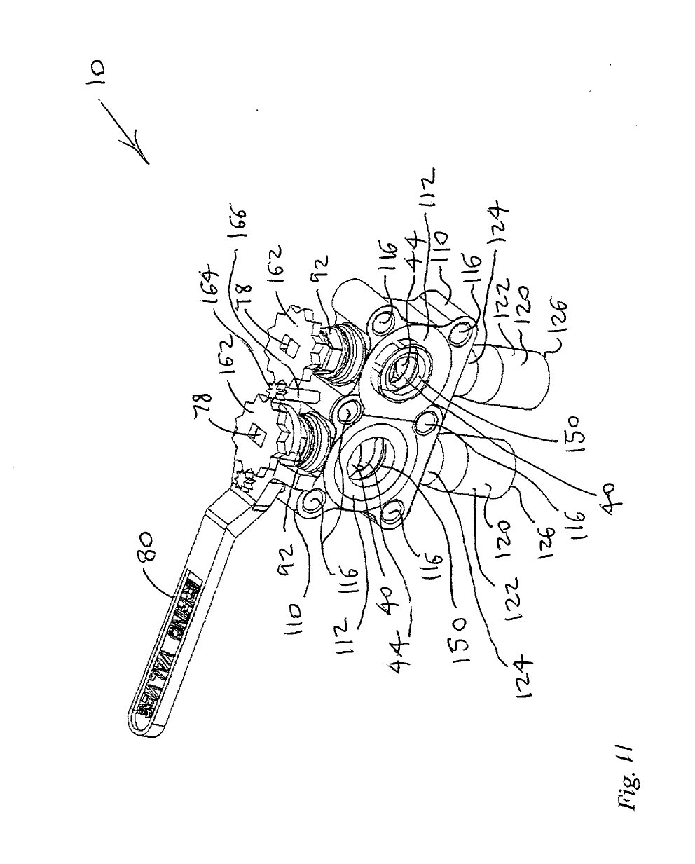

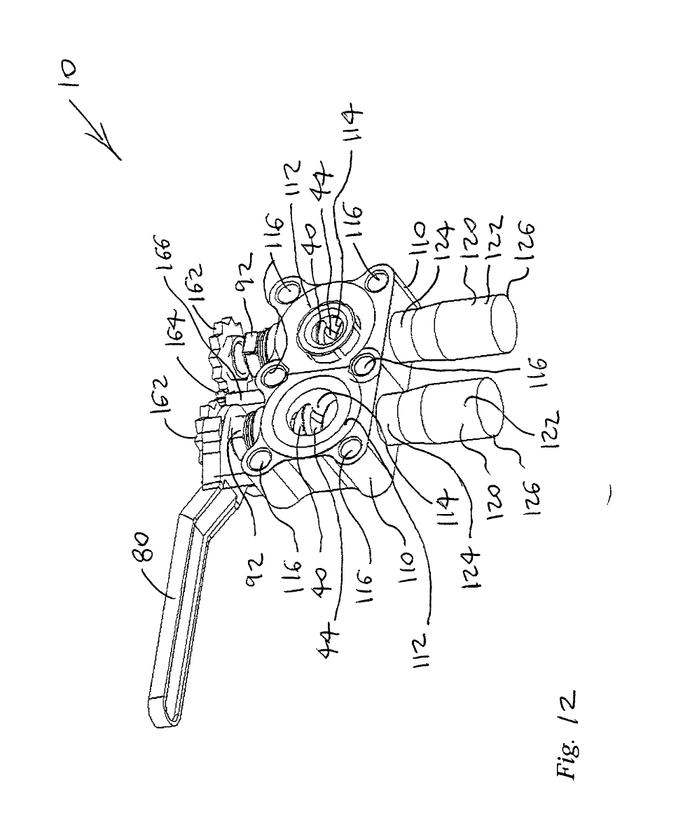

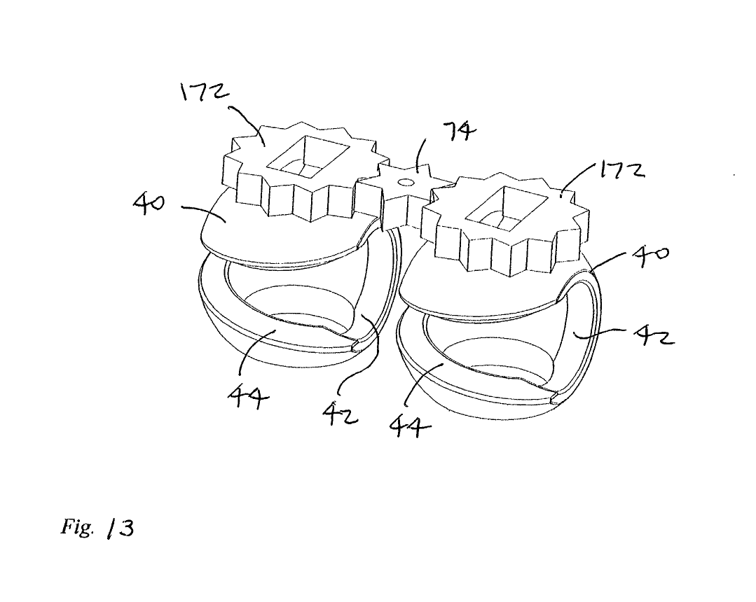

A second embodiment of the ball valve 10 is contemplated which is a double valve including two parallel flow channels 22 each containing one of the above-described valve balls 40, 50 or 60, each valve ball having a valve stem structure 70. The valve balls are inventively rotatably interconnected and mounted in tandem. See FIGS. 11-13. A valve stem gear 162 in the form of a spur gear is mounted on each valve stem structure 70 and a transition gear 164 affixed to a transition stem 166 is rotatably mounted between and meshes with the two valve stem gears 162 and causes one valve ball 40, 50 or 60 to rotate simultaneously, in full synchronization with and in the same direction as the other valve ball 40, 50 or 60. See FIGS. 11 and 12. Synchronization is alternatively accomplished with ball gears 172 directly attached to the valve balls which mesh with a transition gear 174 between them. See FIG. 13.

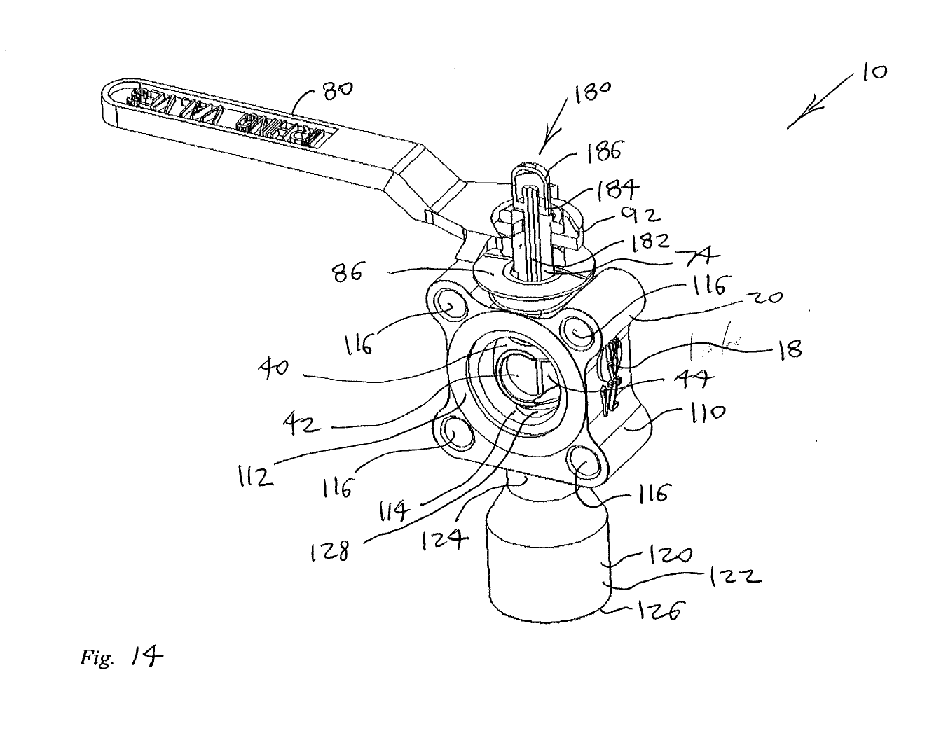

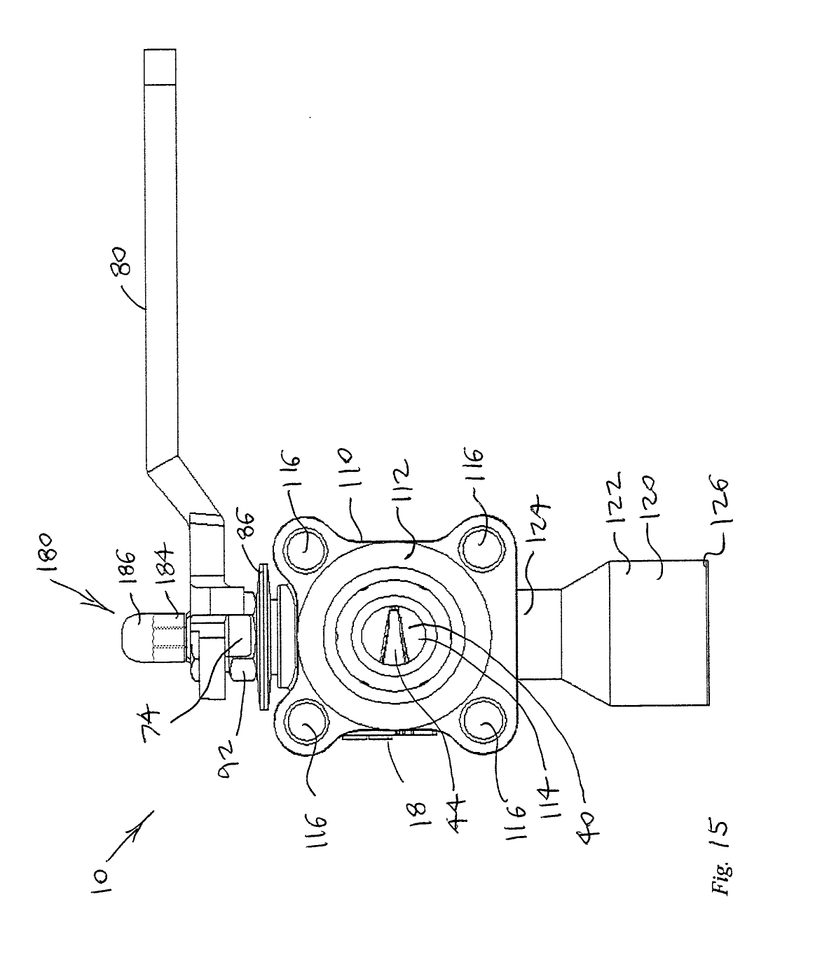

A preferred, although optional, feature of ball valve 10 is an excess pressure indicator 180 including a venturi passageway 182 extending axially within the stem shank 74 which is in fluid communication with the ball channel 22. See FIGS. 14 and 15. The end of the venturi passageway 184 remote from the ball 40, 50 and 60 includes a glass viewing window 186. When the pressure of fluid flowing through ball valve 10 exceeds a certain pre-selected value, a sufficient quantity of the fluid is drawn into the venturi passageway 184 to pass beside and appear in the viewing window 186 and thereby to alert the system operator of the excessive pressure.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A variable control ball valve, comprising:
a valve body containing a valve body flow channel;
a valve ball rotatably mounted within said valve body flow channel, said valve ball having a full volume diametric ball channel with a laterally extending ball channel extension having progressively diminishing cross-sectional area;
and means for rotating said valve ball about a ball rotational axis relative to said valve body flow channel;
such that when said valve ball is rotated beyond the point at which said ball channel is aligned with said valve body flow channel, said valve body flow channel aligns with progressively narrower segments of said ball channel extension and the flow rate through said valve body flow channel is progressively diminished.

2. The variable control ball valve of claim 1, wherein said ball channel extension has a laterally tapered cross-section.

3. The variable control ball valve of claim 1, wherein said valve ball is a hollow sphere comprising:
two diametrically opposed primary flow ports;
wherein said lateral port extension is contiguous with and extends from one said primary flow port to and opens into the other primary flow port and progressively narrows until it reaches and opens into the other said primary flow port.

4. The variable control ball valve of claim 1, wherein said valve ball is a hollow sphere having two diametrically opposed primary flow ports and a series of discrete lateral flow ports which are of progressively smaller cross-section;
such that at least one of said lateral flow ports aligns with said valve body flow channel at specific selected valve ball orientations.

5. The variable control ball valve of claim 4, wherein said lateral flow ports are configured as lateral flow slots which are elongate in the direction of the ball rotational axis.

6. The variable control ball valve of claim 1, wherein said a valve body comprises a composite housing comprising:
a central ball housing having two opposing faces and a central housing passageway and a valve stem port perpendicular to and opening into said central housing passageway;
two opposing ball seating plates fastened onto said opposing faces of said central ball housing, each said ball seating plate having plate bolt ports, a plate central port opening into an outwardly protruding and internally threaded tubular fitting defining a segment of the valve body flow channel, wherein said valve ball is rotatably fitted into said central housing passageway;
two annular valve seats, each said valve seat having an inwardly tapered ball face resting against the valve ball, said valve seats being located on opposing sides of said valve ball, said seating plates being fitted against said opposing faces of said central ball housing such that said threaded fittings both align with said central housing passageway, ball seating plates are in sealing contact with said opposing faces of said central ball housing, and said internally threaded fittings and said central housing passageway together define said valve body flow channel, and a valve stem structure fitted through said valve stem port and comprising valve ball engaging means.

7. The variable control ball valve of claim 6, additionally comprising a valve mounting structure for securing said ball valve to a system mounting structure.

8. The variable control ball valve of claim 1, additionally comprising a valve stem port in said valve body substantially perpendicular to and opening into said central housing passageway.

9. The variable control ball valve of claim 7, wherein said valve mounting structure comprises a mounting tube having internal threads for screwing onto an externally threaded system mounting structure, and protruding from said central ball housing said central housing passageway and having a mounting tube proximal end connected to said central ball housing and a mounting tube distal end.

10. The variable control ball valve of claim 9, wherein said mounting tube distal end is outwardly flared to a wider diameter than the mounting tube proximal end.

11. The variable control ball valve of claim 9, additionally comprising a mounting tube port in said central ball housing which interconnects said central housing passageway with said mounting tube to pass fluid through said mounting tube into a separate line.

12. The variable control ball valve of claim 1, comprising two parallel said flow channels, each said flow channel containing one of said valve balls, each said valve ball being connected to a valve stem structure, wherein said valve balls are rotatably interconnected by gear means for simultaneous rotation.

13. The variable control ball valve of claim 12, wherein said gear means comprise valve stem gears mounted on each valve stem structure and by a transition gear affixed to a transition stem and rotatably mounted between and meshing with said valve stem gears and causing one said valve ball to rotate simultaneously, in full synchronization with and in the same direction as the other said valve ball.

14. The variable control ball valve of claim 12, wherein said gear means comprise drivably interconnected ball gears.

15. The variable control ball valve of claim 8, additionally comprising:
an excess pressure indicator including a venturi passageway extending axially within said valve stem structure and being in fluid communication with said ball channel, the end of said venturi passageway remote from said valve ball including a viewing window, such that when the pressure of fluid flowing through said ball valve exceeds a certain value, a sufficient quantity of fluid passing through said ball valve is drawn into said venturi passageway to pass beside and appear in said viewing window and thereby to alert a system operator of excessive fluid pressure.
